(19) United States
(12) Patent Application Publication
(10) Pub. No.: US 2007/0038534 A1
(43) Pub. Date: Feb. 15, 2007

(54) Distributed peak power tracking solar array power systems and methods

(76) Inventor: Stanley Canter, Hermosa Beach, CA (US)

Correspondence Address: MACPHERSON KWOK CHEN & HEID, LLP, 2033 GATEWAY PLACE, SUITE 400, SAN JOSE, CA, 95110, US

(21) Appl. No.: 11/195,068

(22) Filed: Aug. 1, 2005

(51) Int. Cl. G06Q 40/00

(52) U.S. Cl. 705/35

(57) ABSTRACT

In accordance with at least one embodiment of the present invention, a power system includes a plurality of solar panels in a solar array, with each solar panel configured to receive illumination and produce a panel power output signal for a corresponding power converter. The power converters are configured to produce corresponding converted power output signals as a function of an operating point of the solar panels to provide an array power output signal.

### TECHNICAL FIELD

The present invention relates generally to spacecraft power systems, and more particularly to a distributed peak power solar array power system.

### Related Art

Modern satellites often require extremely accurate and stable pointing systems and may rely on solar arrays with photovoltaic panels to provide electrical power. For example, as shown in FIG. 1, a satellite 100 includes a solar array that is configured as one or more wings (102, 104) which extend out from a satellite body 106. A wing 102 can include a plurality of solar panels (108, 110, and 112) that are oriented in the same direction. For these satellites, a sun-tracking mechanism is typically required to maneuver the satellite 100 or the solar array wings (102, 104) so that the solar panels will receive adequate illumination and produce sufficient power.

A sun-tracking mechanism may employ various devices (e.g., motors, reaction wheels, and/or positioning jets) to ensure the solar panels are pointed towards the sun. However, these mechanisms may not operate smoothly, thereby causing disturbances such as vibration or jitter that may detract from the short-term pointing accuracy of the satellite and result in decreased payload performance.

Conventional approaches to address these problems have been directed to reducing the solar array mass and linear dimensions and by compensating for various noise sources (e.g., jitter) or signal loss. Another approach has been to increase the rigidity of the physical structure supporting the solar array wings, but this generally results in a rapid increase in mass that limited the utility of the design. As a result, there remains a need in the art for improved power systems, such as for satellites and other solar array systems.

### SUMMARY

Systems and methods are disclosed herein, in accordance with one or more embodiments of the present invention, to provide distributed peak power tracking (PPT) techniques. For example, a distributed PPT solar power system is provided, in accordance with one embodiment, which yields increased power output while eliminating the disturbances caused by a conventional sun-tracking system. The distributed PPT solar power system may be employed, for example, to maximize the available power from a segmented solar panel array.

More specifically in accordance with an embodiment of the present invention, a power system includes a plurality of solar panels in a solar array, with each solar panel configured to receive illumination and produce a panel power output signal for a corresponding power converter. The power converters are configured to produce corresponding converted power output signals as a function of an operating point of the solar panels to provide an array power output signal.

In accordance with another embodiment of the present invention, a satellite includes a plurality of solar panels in a solar array configured to provide a plurality of panel power output signals for a PPT solar array power system. The PPT system includes a plurality of power converters, with each power converter corresponding to at least one of the solar panels and configured to receive the corresponding panel power output signals and produce a corresponding converted power output signal as a function of the operating point of the corresponding solar panels. The converted power output signals provide an array power output signal. A back off control unit may be included to provide a back off control signal to reduce the power provided by at least one of the power converters.

In accordance with another embodiment of the present invention, a method of operating a PPT solar power system includes receiving a plurality of solar panel power output signals from a plurality of solar panels in a solar array; converting the plurality of solar panel power output signals to a plurality of converted power output signals as a function of

corresponding operating points for the plurality of solar panels; and combining the plurality of converted power output signals into an array power output signal.

In accordance with another embodiment of the present invention, a method of using a peak power tracking (PPT) solar power system applied to a system of satellites is provided. The satellites may be launched over a period of many years such that the power available from newer satellites arising from the use of the PPT solar power system enhances the capability of the system of satellites such that launch dates or replenishment schedules may be stretched out or extended so as to minimize total system cost or alternatively increase total system capability beyond that available from traditional systems designed to accommodate only the guaranteed end-of-life solar array power requirements.

The scope of the present invention is defined by the claims, which are incorporated into this section by reference. A more complete understanding of embodiments of the present invention will be afforded to those skilled in the art, as well as a realization of additional advantages thereof, by a consideration of the following detailed description. Reference will be made to the appended sheets of drawings that will first be described briefly.

### BRIEF DESCRIPTION OF THE DRAWINGS

FIG. 1 shows a satellite having a solar array configuration requiring a sun-tracking system, where the solar array is mounted on extended wings with a plurality of the solar panels oriented in the same direction, in accordance with an embodiment of the present invention.

FIG. 2 shows a satellite having a peak power tracking (PPT) solar array power system that receives power from a plurality of solar panels set at different angular positions with respect to the satellite body, in accordance with an embodiment of the present invention.

FIG. 3 shows a block diagram view of an exemplary PPT solar array power system for receiving power from a plurality of solar panel segments and providing a power output to a battery or regulated voltage bus, in accordance with an embodiment of the present invention.

FIG. 4 shows a block diagram of an exemplary current-mode pulse width modulator (PWM) DC/DC converter, in accordance with an embodiment of the present invention.

FIG. 5 shows an exemplary table of values illustrating the percentage improvement for a distributed peak power tracking (PPT) solar power system compared with a traditional fixed output solar power system, in accordance with an embodiment of the present invention.

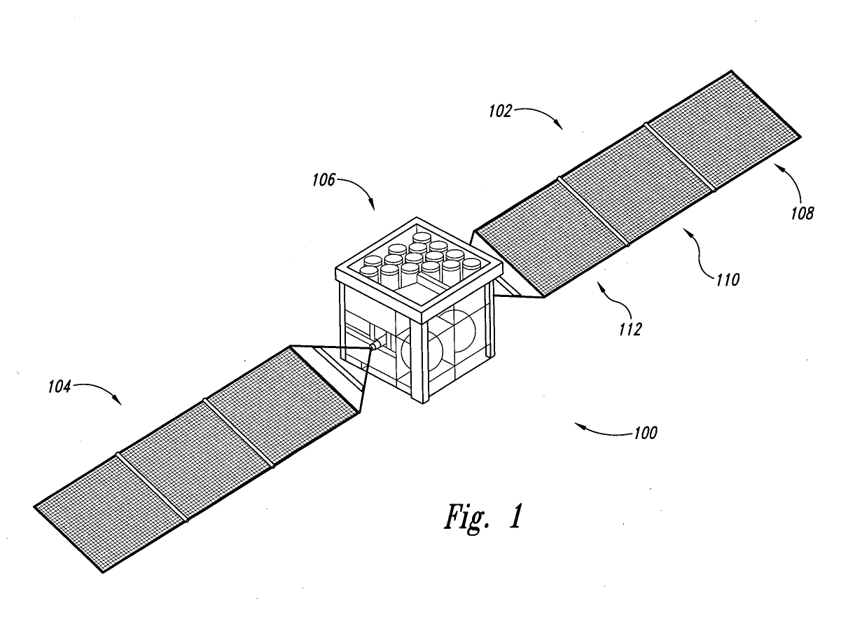

Embodiments of the present invention and their advantages are best understood by referring to the detailed description that follows. It should be appreciated that like reference numerals are used to identify like elements illustrated in one or more of the figures.

### DETAILED DESCRIPTION

In accordance with one or more embodiments of the present invention, distributed peak power tracking (PPT) systems and methods are disclosed, which may allow a solar power system to more fully utilize excess available power from a solar array in a beginning-of-life (BOL) phase of a satellite system life-cycle, as well as compensate for a degradation in performance caused by aging phenomena in an end-of-life (EOL) phase. For example, the systems and methods may be applied to a multi-faceted solar array power system design that minimizes or eliminates the need for a sun-tracking mechanism by maximizing the available power from a segmented or faceted solar array panel layout.

The systems and methods may also be effective in correcting or maximizing energy collected during shadowing events, which occurs when a satellite appendage is positioned between the solar array and the sun vector, thereby blocking illumination of a portion of the solar array. Maneuvering the satellite to change the satellite attitude for target viewing or to access communications links may cause a shadowing event, which can sweep across the solar array over a period of several minutes.

Because the thermal time constant of the solar panels can be on the order of several minutes, a PPT can maximize energy collection during these shadowing events.

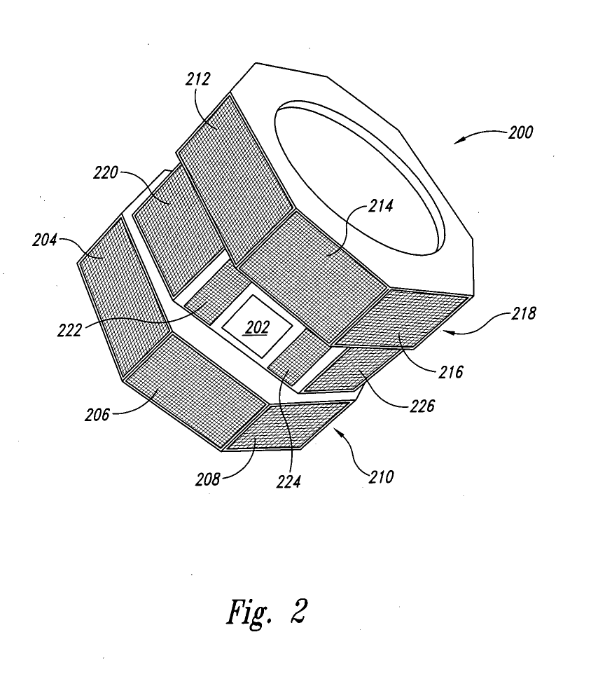

FIG. 2 shows a satellite system 200 including a peak power tracking (PPT) solar array power system 202 that receives power from a plurality of planar solar panels shown in three groups (204-210, 212-2.18, and 220-226) where each solar panel in a group is set at a different angular position with respect to the satellite body. Satellite system 200 may include other solar panels (not shown) having planar or curved (non-planar) surfaces.

For this example, the panels in a group will each receive different levels of illumination from a single light source such as the sun, and as a result will be at significantly different operating temperatures and produce significantly different current outputs. Alternatively, the solar panels may be grouped based on their position on a particular face of the satellite body so that solar panels 204, 212, and 220 may be grouped into a first face group, for example. In yet another alternative, the panels may not be fixed on the satellite body, but may still be fixed in different angular positions relative to the other panels.

In this disclosure, the terms satellite and spacecraft are interchangeable and may refer to any isolated system that derives power from the sun through a plurality of solar panels. Although specifically applied to satellites, the present invention may be used in a terrestrial application (not shown) where a plurality of solar panels are set at different angular positions relative to each other and where the PPT system derives the maximum power (e.g., without a sun-tracking system).

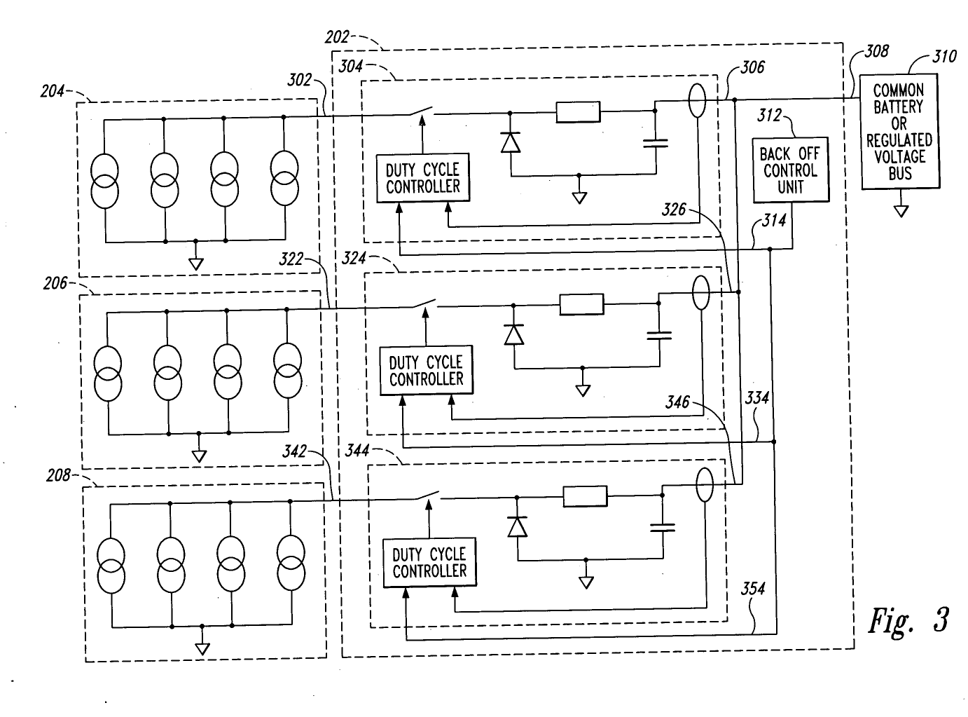

FIG. 3 shows a block diagram view of an exemplary implementation of a distributed PPT solar array power system 30 202, which receives panel power signals from a representative plurality of solar panels segments (204, 206, 208) and provides an array output power signal to a common battery or regulated voltage bus. In general, solar cells produce a direct current (DC) at a typically low voltage that is determined by factors that are collectively referred to as an operating point (OP). Factors that determine the OP include, for example, the amount of incident illumination upon the solar panel, the temperature of the solar panel, and the age of the solar panel.

A plurality of solar cells may be combined into a solar panel and connected serially or in parallel to provide a larger voltage, a larger current, or both. Furthermore, two or more solar panels may have the same orientation on the spacecraft body, with approximately the same operating point, and may supply panel power output signals to the same power converter. A solar panel that is directly facing the sun, where the planar surface of the solar panel is normal to the incident rays of the sun, will likely be at a higher temperature and receive greater illumination than a solar panel that is set at a non-normal angle partially offset from the sun, or where the solar panel is located on a portion of the satellite that is facing away from the sun.

In this embodiment, a first segmented solar panel 204 includes an array of solar (photovoltaic) cells that provide a panel power output signal on bus 302 that is applied to a first power converter 304. First power converter 304 receives the panel power output signal and provides a converted power output signal on bus 306. A second solar panel 206 provides a panel power output signal on bus 322 to a second power converter 324 which then provides a converted power output signal on bus 326. A third solar panel 208 provides a panel power output signal on bus 342 to a third power converter 344 which then provides a converted power output signal on bus 346. In one embodiment, power converters 304, 324, and 344 are current-mode pulse width modulator (PWM) DC/DC converters, but this implementation is not limiting.

The converted power output signals on buses (306, 326, 346) are combined and applied to an array output bus 308 to supply a common battery or regulated voltage bus 310 to provide power to a satellite or other system (e.g., satellite system 200). Unidirectional current flow devices (not shown), such as diodes, may be used to ensure current flows only in one direction from the power converter output buses (306, 326, 346) to the array output bus 308. In this embodiment, battery 310 may be a storage battery for retaining and delivering accumulated electrical energy.

While only three solar panels (204, 206, 208) are shown in FIG. 3, this is not considered limiting. The actual number of solar panels may include more than thirty-two panels or independent panel segments. The distributed or segmented nature of the power system includes the benefit that the panel power output signal of a segmented solar panel, or the output signal of a group of solar panels at a same operating point, may be applied to a power converter that can produce a converted power output signal as a function of the individual operating point of the associated panel or group of panels.

A back off control unit 312 can be used to vary the current output of one or more power converters in order to reduce the power output of the PPT system in the event that the total power supplied by the solar array exceeds the total power demand comprising the combined system load and available storage capacity. As an example, a first back off control signal on control line 314 can be asserted to vary the power output from first power converter 304. Back off control unit 312 can be used to control second power converter 324 and/or third power converter 344 in a similar fashion.

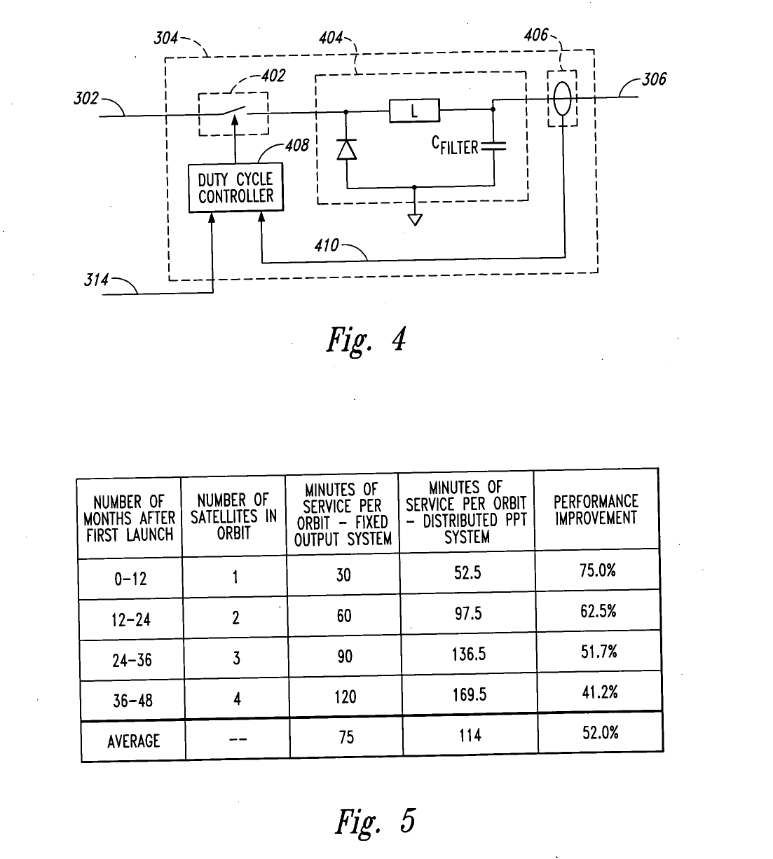

FIG. 4 shows first power converter 304 embodied in an exemplary fashion as a current-mode pulse width modulator (PWM) DC/DC converter. In this embodiment, power converter 304 includes a switch 402, a step-down converter 404, a current sensor 406, and a duty cycle controller 408. Power converter 304 receives a panel power output signal from the associated solar panel 204 on bus 302 and produces a converted power output signal on bus 306. The panel power output signal has a power level P₁ comprising the product of a first voltage V₁ and a first current I₁. In one embodiment, input bus 302 can be a single conductor power bus from first solar panel 204 where the corresponding second conductor may be grounded to the chassis or frame of the power system. Alternatively, both conductors from first solar panel 204 may comprise bus 302. Expressed algebraically, the first power level P₁ is:
P₁=I₁·V₁ Equation-1

Power converter 304 receives the first power level P₁ and produces a converted power output signal having a second power level P₂ comprising the product of a second voltage V₂ and a second current I₂ on output bus 306. Expressed algebraically, the second power level is:
P₂=I₂·V₂ Equation-2

Power converter 304 converts the first power level P₁ to the second power level P₂ in an essentially lossless manner so that the second voltage V2 may be maintained at a predetermined voltage level while the second current I₂ is maximized based on the operating point of first solar panel 204. Expressed algebraically,
P₁=P₂ Equation-3

This may also be expressed algebraically,
I₁·V₁=I₂·V₂ Equation-4

Equation-3 and Equation-4 demonstrate that, while power is reserved in a lossless system, it is possible to adjust the voltage at which the array operates to maximize the power produced by the array while the output voltage is clamped or fixed at the battery or bus voltage. For example, a buck converter (e.g., as part of power converter 304, 324, and 344), in accordance with an embodiment of the present invention, may be provided to maximize the power produced by the array.

Sensor 406 detects current I₂ on bus 306 and provides a duty cycle control signal on control line 410 to duty cycle controller 408. In this manner, the current I₂ on bus 306 is fed back to duty cycle controller 408 which controls the duty cycle, or the ratio of on-time to off-time, of switch 402 in order to maintain the proper voltage level V₂ on bus 306. Furthermore, for example, the output voltage V₂ can be maintained at an approximately constant level while the current I₂ is maximized (e.g., based on the operating point of solar panel 204).

For example, a duty cycle of 50% implies that switch 402 is activated (closed) for one-half of a time period, and a duty cycle of 30% implies switch 402 is activated for 30% of the time period. The lower duty cycle percentage corresponds to a higher array voltage while a higher duty cycle corresponds to a lower array voltage. Therefore, power from the solar array or segment of the solar array can be controlled to achieve any optimum voltage (e.g., between the array open circuit voltage and the bus or battery clamp voltage). Furthermore, power from the solar array or a segment of solar panels can be controlled to provide maximum power by appropriate adjustments to the operating point of the solar array (e.g., operating point on the current-voltage curve for a solar panel).

Duty cycle controller 408 operates switch 402 by varying (increasing or decreasing) the duty cycle based on the current sensed on output bus 306. Similarly, back off control signal 314 is another input to command duty cycle controller 408 to vary the duty cycle of switch 402, thereby controlling the power output of first pulse width modulator (PWM) converter 304 on bus 306. Duty cycle controller 408 may include a sample-and-hold circuit, an oscillator, and a comparator to implement the duty cycle control function (e.g., including dither).

The power converter output currents are combined into an array output current on bus 308 that is the sum of all power converter output currents. Each power converter output current is sensed and controlled independently from the others so that the output power on bus 308 is maximized (e.g., current maximized). Stated differently, this distributed system allows each group of circuits to operate at individually optimized operating points and, as a result, the available power can be much greater than that delivered by a traditional, fixed operating point power system.

Each PWM converter (304, 324, 344) operating at individually optimized operating points can compensate for varying conditions due to different illumination levels, different temperatures, and aging effects. Aging effects can include environmental degradation of a solar array operated in the harsh environment of space and can reduce the available power from a particular array segment by approximately fifty percent over the useful life of the satellite. Because the output current of each converter feeds a fixed array output voltage and because the converters are assumed to be nearly lossless, maximizing the current from each power converter enables peak power output or peak power tracking of the entire array. It is understood that this principle may be applied, for example, to a single panel, regions within a panel, or to a plurality of panels all at the same operating point.

FIG. 5 shows a table of values illustrating the percentage performance improvement for a distributed peak power tracking (PPT) solar power system, as compared with a traditional fixed output solar power system, over a period of four years. Traditional fixed output satellite power systems are typically designed to provide the required power at their end-of-life (EOL) phase with the result that excess power potentially available from the array is discarded early in the life cycle due to inherent limitations of a fixed operating point. When a distributed PPT architecture is used, in accordance with the present invention, this beginning-of-life (BOL) excess power is available to the system. However, space systems based upon a single satellite are frequently unable to utilize this excess power because the system is sized for full performance at the end-of-life phase, and a single constellation space system is complete with the first launch. However, in a system comprised of multiple satellites, such as IRIDIUM or GLOBALSTAR or similar constellations, this excess power is useful over the period during which the constellation is assembled in space.

For example, consider a system of four satellites where one satellite is launched every twelve months until the constellation is complete. Assume for this example that each satellite is designed to provide service in low earth orbit at a utilization specified at thirty percent, which is equivalent to thirty minutes of service, and that the available minutes of service per orbit is limited by power availability within the satellite. Assume further that the initial power available is seventy-five percent greater at the beginning-of-life phase than a traditional fixed operating point design, and that this initial power decreases exponentially over time.

In reference to the table of FIG. 5, for example, a conventional constellation of four, fixed output power satellites, where a new satellite is launched in a one-by-one manner every twelve months for four years, a first fixed output satellite provides 30 minutes of service per orbit. A second fixed output satellite launched in the second year provides another 30 minutes of service for a total of 60 minutes for the two satellites. A third satellite launched in the third year provides another 30 minutes of service for a total of 90 minutes for the three satellites. Finally, a fourth satellite launched in the fourth year provides another 30 minutes of service for a total of 120 minutes for the completed, four-satellite constellation. As a measure of performance, the fixed output satellite constellation provides an average of 75 minutes of service per orbit while the constellation is being assembled.

In contrast, if the first satellite placed into service had a distributed peak power tracking (PPT) power system, the PPT satellite would provide approximately 52.5 minutes of service per orbit. This results in a first year performance improvement of approximately 75% when compared with the fixed output case above. Similarly, a second satellite having a distributed PPT power system and placed into service in the second year provides approximately 45 additional minutes of service for a total of approximately 97.5 minutes of service per orbit. These two satellites yield a performance improvement of approximately 62.5% when compared with the fixed output case above. A third satellite having a distributed PPT power system and placed into service in the third year provides approximately 39 additional minutes of service for a total of 136.5 minutes of service per orbit. These three satellites yield a performance improvement of approximately 51.7% when compared with the fixed output case above. Finally, a fourth satellite having a distributed PPT power system and placed into service in the fourth year provides approximately 36 additional minutes of service for a total of approximately 169.5 minutes of service per orbit. The completed, four-satellite constellation yields a performance improvement of approximately 41.2% when compared with the fixed output case above. As a measure of performance, the distributed PPT satellite constellation provides an average of approximately 114 minutes of service per orbit while the constellation is being assembled which equates to an approximate 52.0% performance improvement while providing the above-mentioned benefits of lower mass and stability improvement.

As a further example, even if only later launched satellites include a PPT solar power system, the increase in available power could enhance the capabilities of the assembled satellite system so that subsequent satellite launch dates or replenishment schedules may be stretched out or extended which can reduce the total system cost. Alternatively, the increase in available power may also increase the total system capabilities beyond that which is available from traditional systems that are designed to accommodate only the guaranteed end-of-life solar array power requirements.

Embodiments described above illustrate but do not limit the invention. It should also be understood that numerous modifications and variations are possible in accordance with the principles of the present invention. Accordingly, the scope of the invention is defined only by the following claims.

I claim:

1. A power system, comprising:
a plurality of solar panels in a solar array, each solar panel being configured to receive illumination and produce a panel power output signal; and
a plurality of power converters corresponding to the plurality of solar panels and configured to receive the panel power output signals from the corresponding solar panels and produce corresponding converted power output signals as a function of an operating point of the corresponding solar panels to provide an array power output signal.

2. The power system of claim 1, wherein the converted power output signals each comprise a converted voltage and a converted current, and the array power output signal comprises an array voltage and an array current with the array voltage being maintained at an approximately constant level, and wherein the array current comprises the sum of the converted currents, with each of the converted currents maximized to enable a peak power output from the solar array.

3. The power system of claim 3, wherein the solar panels are planar and at least one of the solar panels is set in a different angular position relative to at least one of the other solar panels in the solar array.

4. The power system of claim 1, wherein each power converter comprises:
a switch having an input port and an output port, the switch being adapted to control a flow of power to the switch output port from one of the associated solar panels connected to the switch input port;
a step-down converter having an input port and an output port, the step-down converter input port being connected to the switch output port and configured to convert a first current at a first voltage to a second current at a second voltage on the step-down converter output port, the product of the first voltage and the first current being approximately equal to the product of the second voltage and the second current;
a current sensor configured to sense the second current and produce a sensor control signal, and
a duty cycle controller configured to receive the sensor control signal and operate the switch based on a duty cycle to control the flow of power from the associated solar panel to the step-down converter, the sensor control signal controlling the duty cycle to maximize the second current.

5. The power system of claim 4, wherein the step-down converter comprises:
an inductive element having a predetermined inductance value;
a capacitive element having a predetermined capacitive value connected to the inductive element; and
a diode element configured to allow current flow in only one direction, the diode element being connected to the capacitive element and the inductive element,
wherein an input signal is applied to the connection between the inductive element and the diode element, and
wherein the output signal is taken from the connection between the inductive element and the capacitive element.

6. The power system of claim 4, wherein the duty cycle controller is adapted to vary the second current.

7. The power system of claim 6, wherein the output current of each power converter controls the duty cycle of the power converter.

8. The power system of claim 7, wherein the power converters comprise pulse width modulator converters.

9. The power system of claim 1, further comprising:
a back off control unit providing a plurality of back off control signals, each back off control signal being adapted to vary the duty cycle of at least one of the power converters.

10. A satellite comprising:
a plurality of solar panels in a solar array configured to provide a plurality of panel power output signals; and
a peak power tracking (PPT) solar array power system, comprising:
a plurality of power converters, each power converter corresponding to at least one of the solar panels and configured to receive the at least one corresponding panel power output signal and produce a corresponding converted power output signal as a function of the operating point of the at least one corresponding solar panel, the converted power output signals providing an array power output signal; and
a back off control unit providing at least one back off control signal to reduce the power provided by at least one of the power converters.

11. The satellite of claim 10, wherein a voltage of the array power output signal is maintained at an approximately constant level and a current for each of the converted power output signals is maintained to maximize a peak power output from the solar array.

12. The satellite of claim 10, wherein the solar panels are planar and at least one of the solar panels is set in a different angular position relative to at least one of the other solar panels in the solar array.

13. The satellite of claim 10, further comprising at least one of a battery configured to receive the array power output signal and a regulated voltage bus configured to receive the array power output signal.

14. The satellite of claim 10, wherein a number of the solar panels having approximately the same operating point are controlled by the corresponding power converter.

15. The satellite of claim 10, wherein the satellite is one of a plurality of the satellites launched in a sequential manner over a certain time period to form a system of satellites, and wherein at least one of the time periods between subsequent launches may be extended and satellite system capabilities may be enhanced due to the increased power availability from the PPT solar power system.

16. A method of operating a peak power tracking (PPT) solar power system, the method comprising:
receiving a plurality of solar panel power output signals from a plurality of solar panels in a solar array;
converting the plurality of solar panel power output signals to a plurality of converted power output signals as a function of corresponding operating points for the plurality of solar panels; and
combining the plurality of converted power output signals into an array power output signal.

17. The method of claim 16, further comprising:
maintaining a voltage of the array power output signal at an approximately constant level;
sensing a current of one of the converted power output signals; and
controlling the converting operation to maximize the power provided by the solar array.

18. The method of claim 16, further comprising maximizing a current for each of the plurality of converted power output signals to enable a peak power output from the solar array.

19. The method of claim 16, wherein the solar panels are set in a plurality of different angular positions relative to each other.

20. The method of claim 16, further comprising applying the array power output signal to at least one of a battery and a regulated voltage bus.
